(19) United States
(12) Patent Application Publication
(10) Pub. No.: US 2017/0124901 A1
(43) Pub. Date: May 4, 2017

(54) SYSTEM AND METHOD FOR ENABLING A USER TO OVERCOME INTROVERSION

(71) Applicants: Jonnalagadda SASIDHAR, Sleepy Hollow, NY (US); Pranav Kumar MISHRA, Burdwan (IN); Manisha Naresh NAGPAL, Bangalore (IN)

(72) Inventors: Jonnalagadda SASIDHAR, Sleepy Hollow, NY (US); Pranav Kumar MISHRA, Burdwan (IN); Manisha Naresh NAGPAL, Bangalore (IN)

(73) Assignee: DHARMA LIFE SCIENCES LLC, Sleepy Hollow, NY (US)

(21) Appl. No.: 14/934,150

(22) Filed: Nov. 6, 2015

Related U.S. Application Data
(63) Continuation-in-part of application No. 14/931,868, filed on Nov. 4, 2015.

(51) Int. Cl. G09B 19/00

(52) U.S. Cl. CPC G09B 19/00

(57) ABSTRACT

A system is provided for enabling a user to overcome introversion. The system is configured to enable the user to engage in a first and a second activity in a virtual environment, directed to rewire a first and a second defective wiring, respectively. The first defective wiring results in tendency to be selective in information gathering. The second defective wiring results in reduced speed of verbal response to open stimuli. Symptom of the first and the second defective wirings is introversion. Engagement in the second activity is enabled after the user has at least participated in the first activity. Automated instructions are provided to the user to engage in activities performed in a real world environment directed to rewire the first and the second defective wiring.

### CROSS REFERENCE TO RELATED APPLICATION

This application is a continuation-in-part application of U.S. patent application Ser. No. 14/931,868 filed Nov. 04, 2015 entitled SYSTEM AND METHOD FOR ENABLING A USER TO OVERCOME WEAK BEHAVIORAL TRAITS, which is hereby incorporated herein by reference. Benefits of priorities to all related applications are claimed.

### BACKGROUND

Unless otherwise indicated herein, the materials described in this section are not prior art to the claims in this application and are not admitted to be prior art by inclusion in this section.

The subject matter in general relates to behavioral traits in humans, and more particularly but not exclusively, the subject matter is directed to a. technical solution to overcome introversion, which is a behavioral trait that some may need to overcome based on their goals. A trait can be referred to as a weak trait if it inhibits that person from reaching his or her goals.

An individual's behavior towards others, attitudes and characteristics, defines his personality. Each individual's personality is a combination of both positive and negative traits. A person may be driven by his positive traits at times and by negative traits at other times. As a result, to classify a person into a single personality type is difficult, as there are several different behavioral traits a person can have. Behavioral traits may be influenced by genes and/or by the environment where he grew up or may have spent most of his time during the stage of brain development. As an example, introversion may be caused by genetic predisposition to give priority to internal thinking over external stimulation, and lack of exposure and rewards from social environments during childhood.

Understanding what makes people who they are has been a challenge in the world of psychology. One of the approaches used for determining the personality of a person is by way of taking a psychology based personality test. In such a test, the person answers a set of questions, and based on the answers gets a report detailing the type of personality that person may have. On the other hand, behavior of a person may be observed to determine weak personality traits in him. Behavior of a person who is an introvert may include, the person preferring individualistic activities, withdrawing from or feeling drained in social situations, being driven by long term intrinsic rewards and preferring to avoid initiating/indulging in small talk.

Negative or weak traits in a person can lead to difficulty in achieving their life goals. Conventionally, people try to overcome their weaknesses when one understands one's weaknesses or weak traits. An individual may approach a counselor or a psychologist with a view that, the counselor or the psychologist may be able to help him address his negative or weak trait. The person may have to undergo several sessions with the counselor. Such sessions may deal with the negative trait via, a broad based general (not focused at the root of the weak trait) approach, which may be effective in the short run. For example, if a person is trying to deal with stress, the person may be advised to engage in regular exercise, outdoor games, engage socially and so on, which may prove effective to an extent for the time being.

Currently, there are multiple games and applications that may work in the same way as a counseling process. Even these games deal with the negative trait via a general approach. As an example if a person is not capable of reading at good speed, the person is subjected to games related to reading to improve his speed of reading. Such approach may be effective in the short run and does not address negative traits in a wholesome manner.

In light of the foregoing discussion there is a need for an improved technique to overcome introversion, which can be classified as a weak personality trait based on the goals of the person.

### SUMMARY

An embodiment provides a system for enabling a user to overcome introversion. The system includes an activity module. The activity module is configured to enable the user to engage in at least a first activity in a virtual environment. The first activity is directed to rewire a first defective wiring of the brain. The first defective wiring results in tendency to be selective in information gathering. The activity module is further configured to enable the user to engage in at least a second activity in the virtual environment. The second activity is directed to rewire a second defective wiring of the brain. The second defective wiring results in reduced speed of verbal response to open ended stimuli. Symptom of the first and the second defective wirings is introversion. Engagement in the second activity is enabled after the user has at least participated in the first activity. Additionally, the activity module is configured to provide automated instructions to the user to engage in at least one activity, wherein the one activity is performed in a real world environment. The activity is directed to rewire the first defective wiring of the brain. Furthermore, the activity module is configured to provide automated instructions to the user to engage in yet another activity. The yet another activity is performed in the real world environment. The yet another activity is directed to rewire the second defective wiring of the brain.

Another embodiment provides a method for enabling a user to overcome introversion. The method includes enabling the user to engage in at least a first activity in a virtual environment. The first activity is directed to rewire a first defective wiring of the brain. The first defective wiring results in tendency to be selective in information gathering. The user is further enabled to engage in at least a second activity in the virtual environment. The second activity is directed to rewire a second defective wiring of the brain. The second defective wiring results in reduced speed of verbal response to open ended stimuli. Symptom of the first and the second defective wirings is introversion. Engagement in the second activity is enabled after the user has at least participated in the first activity. Further, automated instructions are provided to the user to engage in at least one activity. The one activity is performed in a real world environment. The activity is directed to rewire the first defective wiring of the brain. Furthermore, automated instructions are provided to the user to engage in yet another activity. The yet another activity is performed in the real world environment. The vet another activity is directed to rewire the second defective wiring of the brain.

Yet another embodiment provides a system for enabling a user to overcome introversion. The system includes an activity module configured to enable the user to engage in at least a first activity in a virtual environment, wherein the first activity is directed to rewire a first defective wiring of the brain, wherein the first defective wiring results in tendency to be selective in information gathering. The activity module is further configured to enable the user to engage in at least a second activity in the virtual environment, wherein the second activity is directed to rewire a second defective wiring of the brain, wherein the second defective wiring results in reduced speed of verbal response to open ended stimuli, wherein symptom of the first and the second defective wirings is introversion, wherein engagement in the second activity is enabled after the user has at least participated in the first activity.

### BRIEF DESCRIPTION OF THE DRAWINGS

Embodiments are illustrated by way of example and not limitation in the Figures of the accompanying drawings, in which like references indicate elements and in which:

FIG. 1 is an exemplary architecture of an exemplary system 100 to overcome introversion;

FIG. 2 is a block diagram of an exemplary activity module 200 to overcome introversion;

FIG. 2A is a block diagram of an exemplary behavioral traits database 202 of the activity module 200;

FIG. 2B is a block diagram of an exemplary collection of games 204 present in the activity module 200 to overcome introversion;

FIG. 2C is a block diagram of an exemplary actions database 206 of the activity module 200 to overcome introversion; and

FIGS. 3A and 3B illustrate a flowchart of an exemplary method for overcoming introversion.

### DETAILED DESCRIPTION

I. OVERVIEW
II. UNDERLYING SCIENTIFIC PRINCIPLE
III. SYSTEM ARCHITECTURE
IV. MODULES OF SYSTEM TO OVERCOME INTROVERSION
V. METHOD FOR OVERCOMING INTROVERSION

The following detailed description includes references to the accompanying drawings, which form part of the detailed description. The drawings show illustrations in accordance with example embodiments. These example embodiments are described in enough detail to enable those skilled in the art to practice the present subject matter. However, it will be apparent to one of ordinary skill in the art that the present invention may be practiced without these specific details. In other instances, well-known methods, procedures and components have not been described in detail so as not to unnecessarily obscure aspects of the embodiments. The embodiments can be combined, other embodiments can be utilized or structural and logical changes can be made without departing from the scope of the invention. The following detailed description is, therefore, not to be taken as a limiting sense.

In this document, the terms “a” or “an” are used, as is common in patent documents, to include one or more than one. In this document, the term “or” is used to refer to a nonexclusive “or,” such that “A or B” includes “A but not B,” “B but not A,” and “A and B,” unless otherwise indicated.

### I. Overview

Embodiments provide a technical solution to overcome introversion, which is a weak behavioral trait. The solution is based on a principle that genetic and environmental factors (may be referred to as “cause”) cause defects in human brain wiring (may be referred to as “defect”), and such defects in human brain wiring express themselves in the form of introversion (may be referred to as “symptoms”); hence, to overcome introversion, the defective brain wirings have to be rewired, thereby providing a wholesome and long term solution to weak behavioral traits.

In an embodiment, a system is provided to overcome introversion. The system may include an activity module. The activity module may be configured to enable the user to engage in activities in a virtual environment. The activities in the virtual environment facilitate rewiring of defective brain wirings, wherein the symptom of the defective brain wirings is introversion. The activity module may be further configured to provide automated instructions to gradually expose the user to situations in a real environment. The situations may be generally uncomfortable to the user as a result of the defective brain wirings. Exposure to such situation facilitates rewiring of the defective brain wirings.

The activity in the virtual environment may be a brain game. There may a plurality of levels in the brain game. Each level in the game may have to be successfully completed by the user to unlock a subsequent higher level in the game.

The exposure activity may take place in the real world environment, subsequent to the brain games. There may be a plurality of levels in the exposure activity.

### II. Underlying Scientific Principle

Introversion is in fact a symptom or consequence of the way an individual's brain is wired. The way an individual's brain is wired is based on the joint influence of genetic and environmental factors. With regards to each kind of brain wiring, genetic and environmental factors may work together in different proportions.

With regards to introversion, the brain of the introvert is wired such that the person tends to be selective in information gathering, which may be considered as a defective brain wiring. Additionally, the brain of the introvert is wired such that speed of verbal response to open ended stimuli is reduced, which may be considered as another defective brain wiring. Such defective brain wiring may have been caused by one or more of genetic predisposition to give priority to internal thinking over external stimulation and lack of exposure and rewards from social environments during childhood.

As an example, an individual as a kid may not have had exposure and rewards from social environments (environmental factors). Said environmental factor along with genetic factors that may be present, cause the defective brain wirings.

Embodiments provide a solution to rewire the defective brain wirings (addressing the defect) rather than just addressing the behavioral trait (symptom) without addressing the core defect. The solution is directed towards rewiring the defective brain wirings such that the ability to gather information concurrently from multiple sources is increased and speed of verbal response to open ended stimuli is increased.

It is important to identify the brain wiring that results in development of a trait. A wholesome approach to overcome or eradicate a negative or a weak behavioral trait in a person would be to implement ways to rectify defect in the brain wiring.

Brain wirings may be referred to as connections of neural pathways in the brain. These connections of the brain form beliefs, thought patterns and response patterns to external stimulation. Rewiring may be referred to as a process of creating new brain wiring and stimulating a person's existing brain wirings so that his beliefs, thought patterns and responses to external stimulation change for the better.

### III. System Architecture

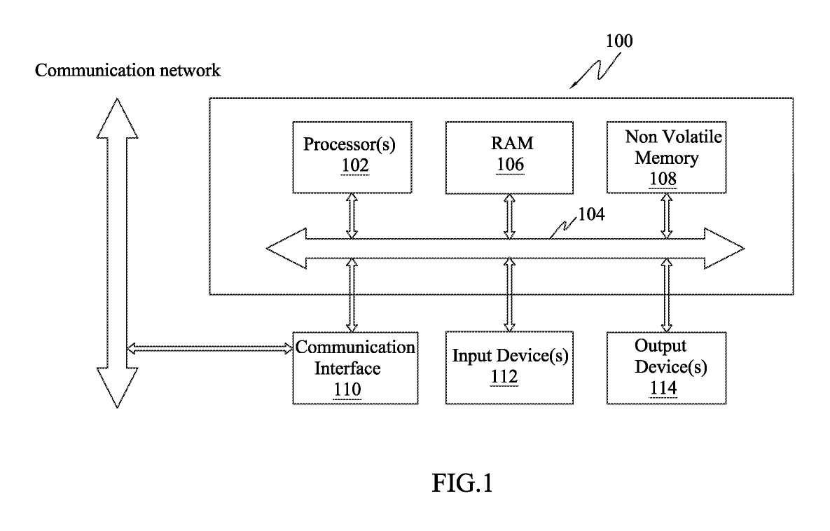

Referring to the figures, more particularly to FIG. 1, an exemplary architecture of an exemplary system 100 to overcome introversion is provided. The system 100 include one or more processors 102, a bus system 104, a random access memory 106, a disk drive or non-volatile memory 108, a communication interface 110, input device(s) 112 and output device(s) 114. Further, functionality of the system 100 may be distributed across multiple devices that may be located remotely from each other.

The processor 102 may be any hardware which returns output by accepting signals, such as electrical signals as input in one embodiment, processors 102 may include one or more computer processing units (CPUs). The processor(s) 102 may communicate with a number of peripheral devices via the bus system 104. The processor(s) 102 may be implemented as appropriate in hardware, computer-executable instructions, firmware, or combinations thereof. Computer-executable instruction or firmware implementations of the processor(s) 102 may include computer-executable or machine-executable instructions written in any suitable programming language to perform the various functions described.

Communications interface 110 may provide an interface to other communication networks and devices. The input devices 112 may include all possible types of devices and mechanisms for inputting information to system 100. The output devices 114 may include all possible types of devices and mechanisms for outputting information from the system 100. The system 100 may include memory that may store data and program instructions that are loadable and executable on the processor(s) 102, as well as data generated during the execution of these programs. The memory may be volatile, such as random access memory 106 and/or a disk drive or non-volatile memory 108.

### IV. Modules of System to Overcome Introversion

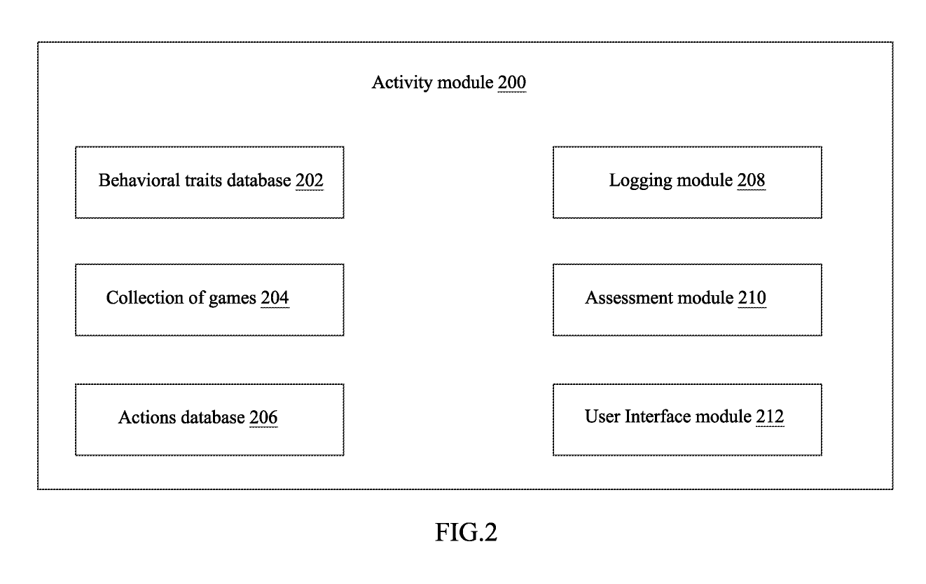

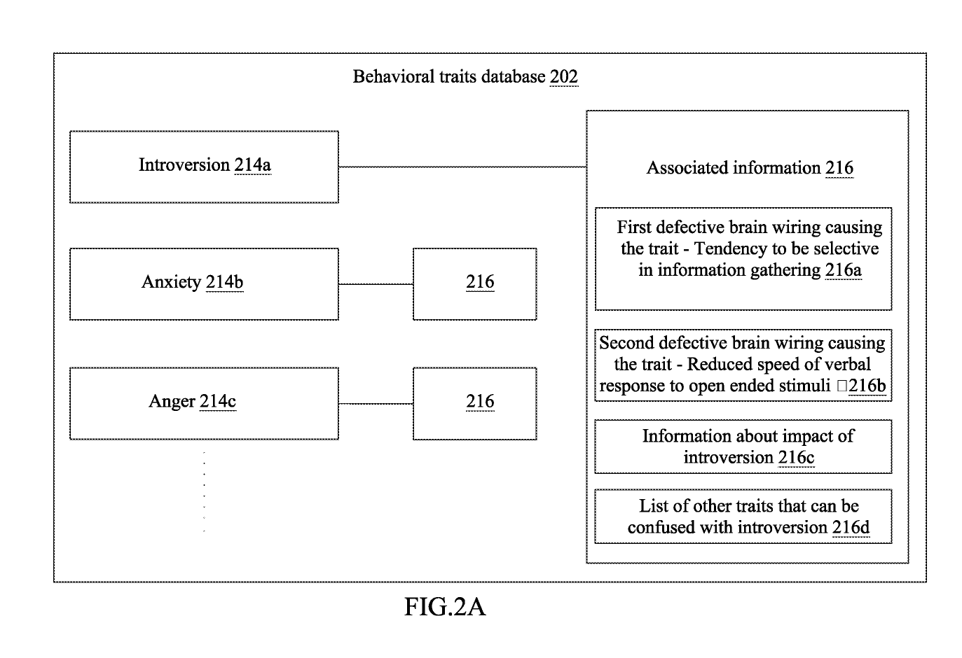

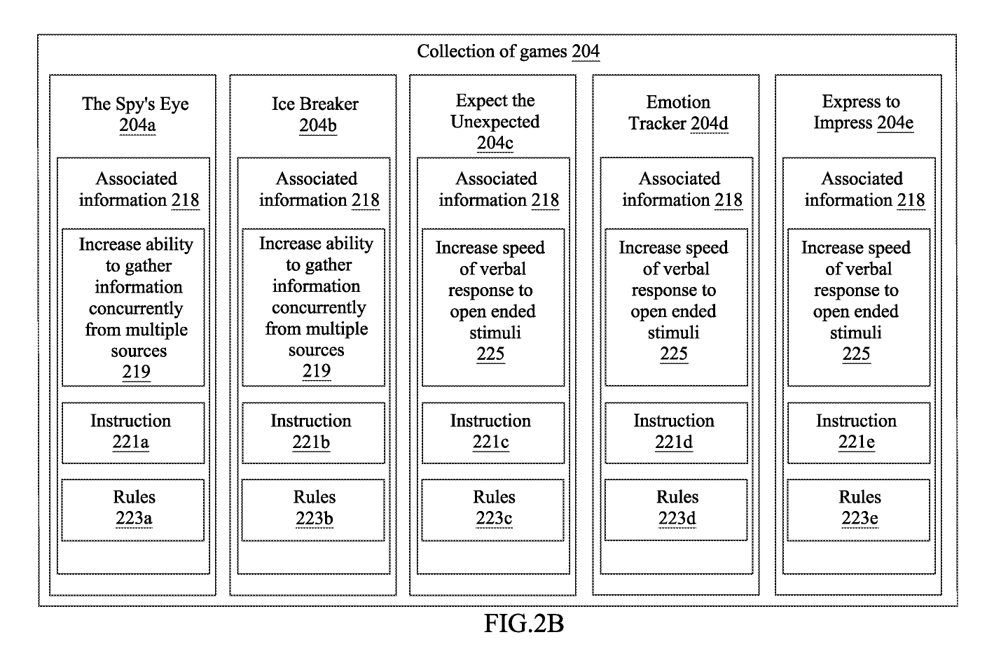

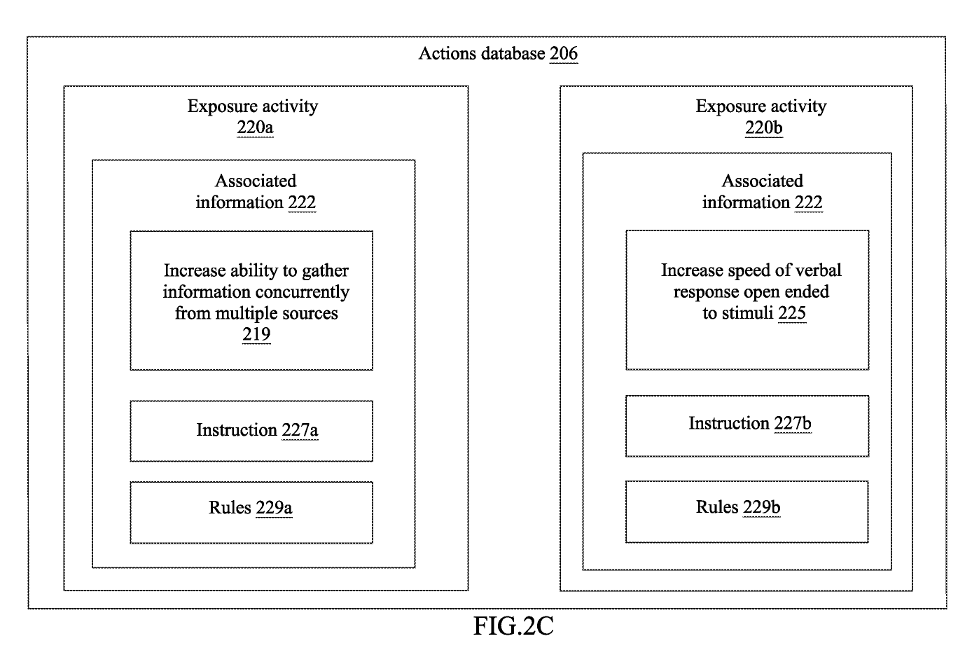

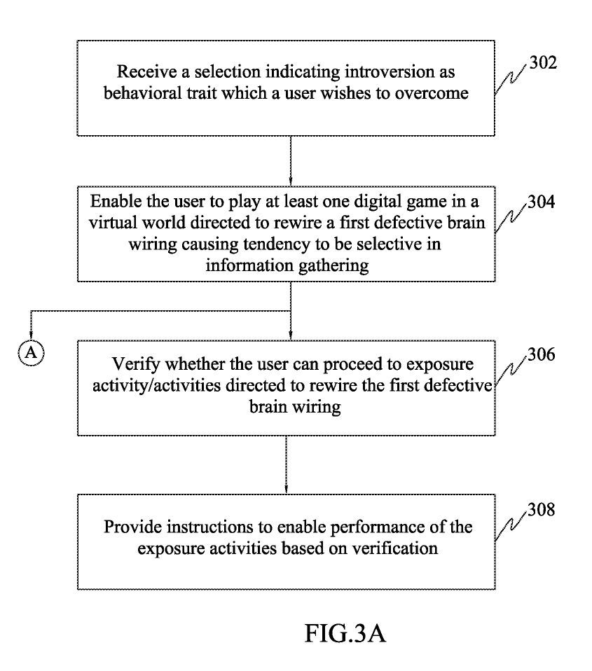

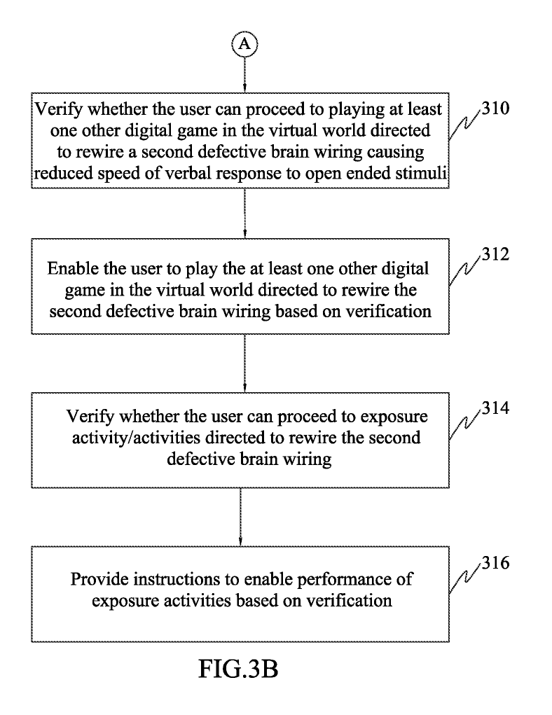

Referring to the figures, and more particularly to FIG. 2, the system 100 includes various modules for enabling users to overcome introversion. The system 100 includes an activity module 200. The activity module 200 may be a gaming module or an application module. The activity module 200 may be hosted by a communication device that enables a user to play games. Examples of such communication devices may include smart phone, tablet, notebook, laptop and desktop computer, among other devices.

The activity module 200 may include a behavioral traits database 202, a collection of games 204, an actions database 206, a logging module 208, an assessment module 210 and a user interface module 212.

### Behavioral Traits Database 202

Referring to FIG. 2A, in an embodiment, the behavioral traits database 202 may include a list of behavioral traits 214. Examples of behavioral traits 214 include, but not limited to, introversion 214a, anxiety 214b and anger 214c, among others. The traits database 202 may further include, with respect to one or more of the behavioral traits, information associated 216 with the trait 214.

With regards to introversion 214a, the associated information 216 may include information corresponding to the defective brain wirings (defects) 216a, 216b causing introversion (symptom of the defect), information about impact 216c of introversion 214a on a person, and a list 216d comprising one or more traits that may be confused with introversion 214a, among other information. Some or all of the associated information 216 may be displayed to the user of the activity module 200.

A first defective brain wiring 216a causing introversion 214a is the brain wiring causing tendency to be selective in information gathering. A second defective brain wiring 216b causing introversion 214a is the brain wiring causing reduced speed of verbal response to open ended stimuli.

An open ended stimuli, as an example is a stimuli to which a response is generally in the form of one or more of commentary, explanation, elaboration, description, review and narration, as opposed to a stimuli (ex: objective question) to which a response (ex: correct answer) to the stimuli is predetermined, such a stimuli might require a person to select a solution from a set of choices, identify an object or position or supply brief numeric or text responses.

In an embodiment, the information corresponding to the first and second defective brain wiring 216a, 216b causing the introversion 214a enables the activity module 200 to select games, activities or actions to overcome introversion.

In an embodiment, displaying the information corresponding to the defective brain wiring (defect) 216a, 216b causing introversion 214a helps the user in understanding the defects responsible for introversion 214a, thereby motivating the user to follow the instructions provided by the activity module 200.

Information about impact of introversion 216c can include one or more of preferring individualistic activities, withdrawing from or feeling drained in social situations, being driven by long term intrinsic rewards and preferring to avoid initiating/indulging in small talk.

List of other traits that can be confused with introversion 216d include social anxiety, self esteem and submissiveness.

In an embodiment, the activity module 200 displays the information corresponding to the brain rewiring that the activity module 200 is attempting to achieve to overcome the weak behavioral trait 214, thereby enabling the user to understand the actual goal he will be instructed to work towards, which in turn can overcome introversion 214a.

With regards to introversion 214a, the brain rewiring attempted to achieve to overcome introversion 214a includes rewiring the defective brain wirings 216a, 216b such that ability to gather information concurrently from multiple sources is increased and speed of verbal response to open ended stimuli is increased.

In an embodiment, the activity module 200 may display the information corresponding to the causes (genetic or environmental) that resulted in the defective brain wirings (defect) 216a, 216b, which in resulted in introversion 214a, thereby enabling the user to relate to the cause, defect and symptom of the defect, which results in an wholesome experience while working to overcome introversion 214a.

### Collection of Games 204

The activity module 200 includes a collection of digital games 204, which are played in a virtual world. Each of the games 204 is used by the activity module 200 based on the brain rewiring, which the game 204 is capable of achieving.

Referring to FIG. 2B, in an embodiment, each game 204a-204e . . . (may be referred to as game 2(34 or games 204) may include associated information 218. As an example, a game may be capable of achieving more than one type of brain rewiring. Each game 204 includes data indicating the brain rewiring(s) 219, 225 it is capable of achieving, so that the activity module 200 can opt to present a choice of one or more games, which has the capability to achieve the brain rewiring, which the activity module 200 is attempting to achieve.

The associated information 218 may further include instructions be followed by the user to play the game 204. The associated information 218 may additionally include one or more rules 223. Examples of rules include rules for playing each game, rules to proceed to a higher level, scoring method in each level and time assigned to each level to reach the end of the level, among others.

In an embodiment, a higher level of the digital game 204 is unlocked based on predefined criteria.

In an embodiment, the higher level is unlocked upon repeatedly playing a previous level in the digital game 204 for a predefined number of times or duration of time.

In the example presented in FIG. 2B, five different games 204a-204e are included in the collection of games 204. The five games viz. the Spy's Eye 204a, Ice Breaker 204b, Expect the Unexpected 204c, Emotion Tracker 204d and Express to Impress 204e can be used by the activity module 200 to correct the defective brain wirings 216a, 216b by rewiring the brain to increase the ability to gather information concurrently from multiple sources 219 and increase speed of verbal response to open ended stimuli 225.

The games, the Spy's Eye 204a and Ice Breaker 204b are directed at rewiring the brain to increase the ability to gather information concurrently from multiple sources 219. The games, Expect the Unexpected 204c, Emotion Tracker 204d and Express to Impress 204e are directed at rewiring the brain to and increase speed of verbal response to open ended stimuli 225.

The Spy's Eye 204a game may be designed to enhance one's observational skills and rewire the brain to increase the ability to gather information concurrently from multiple sources 219. The instruction 221a may include recommendation to play the game 204a for at least a predefined duration for a predefined number of days. The rules 223a may allow proceeding to a next level in the game 204a once a desired level of performance is achieved.

In a first level, a fish tank kept in a restaurant may be shown to the user. Only one fish may be shown initially and the user has to follow the fish in which ever direction it moves along with many other fish. After some duration, the screen may come to a halt and the user has to point out which fish was shown initially. The complexity may be increases in the form of increasing speed of the movement of several fish and number of fish.

In a second level, two customers on a table in the restaurant may be shown. The user has to remember the customer's order (name and look) and seating location. The order shown may include drinks, appetizers, main course, and dessert. The user has to start by memorizing the orders of each of the diners within a predefined duration.

In a third level, which may be similar to the previous level, except that the seating location of the diners may be changed. Subsequently, after some intentional distraction, the user will have to serve their food as ordered. The difficulty of this level increases because the user may associate the order with place “A”, however, while serving, the user has to serve the food at place “B”. This requires heightened observational skill.

In a fourth level, the user has to observe an ideal dining table for a predefined duration and after sonic intentional distraction, the user has to inspect how similar this table is, to what was shown initially. The difficulty level could increase till the user identifies the things on the second table that weren't there in the first one. Intentional distraction may involve matching questions regarding country name with respective to their capital, currency, national game and national anthem, as examples.

In a fifth level, which may be similar to the second and the third level, except that the number of customers may increase. One by one, each of the guests' orders may be displayed. The user has to observe the dishes associated with the customers. After a set of intentional distraction questions, the user has to serve the food to all the guests.

The Ice breaker 204b game may be designed to enhance one's observational skills and rewire the brain to increase the ability to gather information concurrently from multiple sources 219. The instruction 221b may include recommendation to play the game 204b for at least a predefined duration for a predefined number of days. The rules 223b may allow proceeding to a next level in the game 204b once a desired level of performance is achieved.

In a first level, the user may be introduced to a number of people in the game. Facts such as name of the person, field of work and their hobby may be mentioned. The user has to associate these facts with the person and remember them as they will be questioned on it later.

In a second level, the user may be introduced to a number of new people. In addition to the person's name, field of work and hobby, a word (starting with the same letter as the name of the person) is used to describe the personality of that person may also be given. The user has to again associate these facts with the person and remember them as they will be questioned on it later.

In a third level, which may be similar to the previous level, except that the facts about the people and their names may be more similar and sometimes even overlapping, thereby, increasing complexity and making it more challenging for the user to associate facts with the person and remember them. The user has to again associate these facts with the person and remember them as they will be questioned on it later.

The Expect the Unexpected 204c game may be designed to increase speed of verbal response to open ended stimuli 225 increasing speed of verbal response to open ended stimuli helps introverts enhance their speed of verbal processing skills in a number of different situations, which are required in daily life. The speed at which the brain processes verbal responses in open ended situations has an impact on effectiveness in reacting to those events and helps in social situations. This is a skill that can help one feel more confident and comfortable in situations where you have to respond quickly. The instruction 221c may include recommendation to play the game 204c for at least a predefined duration for a predefined number of days. The rules 223c may allow proceeding to a next level in the game 204c once a desired level of performance is achieved.

In a first level, the user may be given one word at a time and he/she would have to respond as quickly as possible with the first word/thought that comes to their mind after seeing that word. They would also be required to make a sentence which connects the word shown and the word they thought of. Points will be given based on how fast they respond to the word which would be shown. The time limit to answer could be predefined, after which the next word would appear on the screen. They would have to play the game till they finish responding to at least a predefined number of words each time.

As an example, word shown on the screen could be “Rain”. The word the user can think of could be “Road/Bike”. The sentence that could be formed by the user could be “I love walking on the road when it is raining” or “I love riding my bike when it is raining.

A second level may be directed towards improving speed of processing in different neutral situations, which is required by a person to have general conversations with the others. A list of words may be shown after a question/situation. The user has to make a sentence (respond) by picking any one of the words shown. The words may be a mixture of extroverted words and introverted words. A clock may start ticking when they start answering the question and stops when they finish with their answer. The game may measure the time the user has taken to think about the answer and that would be a measure of their speed of processing. The user will get points to proceed to the next level only when they make a sentence from any one of the extroverted words.

As an example, the game 204c may suggest a situation that a colleague comes to him and asks him about his opinion on Which team is stronger in football and who has more chances of winning the upcoming match. The game 204c may further provide a choice of words/phrases such as, outstanding player, no idea, depends, excitement, playing conditions and definitely. An extroverted answer of the user could be, as an example, “I am so excited for the upcoming match”, “I know Mr. X is an outstanding player and his team will win” or “Team A will definitely win the upcoming match”. On the other hand, an introverted answer (for which he may not get any points) could be, as an example, “It depends on playing conditions” or “I am not sure who will win”.

The complexity of this level may be increased by decreasing the number of extroverted words, as an example, out of a choice including four words, three words would be introverted and one word would be extroverted. The complexity may also be increased by giving the user more statements than questions. As an example a statement could be “Your food smells good” and the options provided could include “Taste”, “Thank you”, “Depends” and “Awesome”.

A third level could be directed towards improving speed of processing information in different situations which require a person to be witty and stand up for oneself. A list of words may be shown after the question and the user has to make a sentence (respond) by picking any one of the words shown. The words can be mixture of extroverted words and introverted words. A clock may start ticking when they start answering the question and stop when they are finished with their answer. This will measure the time the user has taken to think about the answer and that would be a measure of their speed of processing. The user may get points to proceed to the next level only when they make a sentence from the extroverted words.

As an example, the game 204c can present a situation such as “Your boss thinks that your performance will get affected by you going out and partying and he says this to you in a meeting”, and the game 204c may present a question such as “What would you reply to him?”. Further, the game 204c may present a choice of answers such as “Sorry”, “Hard work”, “Rejuvenate”. “Next time”, “Creative”, “Break”, “Quiet”, “Reduce” and “Social life”. An extroverted answer could be “Partying gives us a break from work life and rejuvenates me”, and an introverted answer (for which the user may not get any points) could be “I am sorry. I will work hard the next time.”

Scoring in the game 204c may be done by giving the user points if he picks any one of the extroverted words. The user may also get points based on how fast they come up with a sentence which includes that word. The timing of the reply may be based on the first word that they begin inputting. An option, such as restart/replay may be provided so that they can change the sentence if they think they made a mistake.

The Emotion Tracker 204d game may be designed to increase the speed of verbal response to open ended stimuli 225, and more specifically to exercise the social cognition network in the user's brain. The game 204d may be specifically designed to improve the way brain processes social input, so that one can correctly interpret facial expressions and body language. The instruction 221d may include recommendation to play the game 204d for at least a predefined duration for a predefined number of days. The rules 223d may allow proceeding to a next level in the game 204c once a desired level of performance is achieved.

In a first a face may be shown briefly on the screen. The user has to decide what expression they think it shows. The user will see a set of words and they have to choose the one showing the same expression as the face that they saw. A list of emotions to be shown can include neutral, happy, sad, fearful, angry, surprised, disgusted, happily surprised, happily disgusted, sadly fearful, sadly angry, sadly surprised, sadly disgusted, fearfully angry, fearfully surprised, fearfully disgusted, angrily surprised, angrily disgusted, disgustedly surprised, appalled, hatred, and awed.

In a second level, a picture of a person exhibiting a particular body language may be shown on the screen. The user has to decide the meaning of that body language. The user may be shown a set of words and he has to choose the one describing the body language which was shown. A list of body language and associated meaning are provided in Table 1 as an example.

TABLE 1

| Body Language | Meaning |
|---|---|
| Brisk, erect walk | Confidence |
| Standing with hands on hips | Readiness, aggression |
| Sitting with legs crossed, foot | Boredom |
| kicking slightly | |
| Sitting, legs apart | Open, relaxed |
| Arms crossed on chest | Defensiveness |
| Walking with hands in pockets, | Dejection |
| shoulders hunched | |
| Hand to cheek | Evaluation, thinking |
| Touching, slightly rubbing nose | Rejection, doubt, lying |
| Rubbing the eye | Doubt disbelief |
| Hands clasped behind back | Anger, frustration, apprehension |
| Locked ankles | Apprehension |
| Head resting in hand, eyes | Boredom |
| downcast | |
| Rubbing hands | Anticipation |
| Sitting with hands clasped behind | Confidence, superiority |
| head, legs crossed | |
| Open palm | Sincerity, openness, innocence |
| Pinching bridge of nose, eyes | Negative evaluation |
| closed | |
| Tapping or drumming fingers | Impatience |
| Steepling fingers | Authoritative |
| Patting/fondling hair | Lack of self-confidence; |
| | insecurity |
| Quickly tilted head | Interest |
| Stroking chin | Trying to make a decision |
| Looking down, face turned away | Disbelief |
| Biting nails | Insecurity, nervousness |
| Pulling or tugging at ear | Indecision |
| Prolonged tilted head | Boredom |

The Express to Impress 204e game may be designed to increase speed of verbal response to open ended stimuli 225. More particularly game 204e may be designed to enable a user to understand what needs to be asked and spoken in social situations.

In a first level, the user may be shown a number of participants. The user has to play a game where each one asks the other questions in order to get to know more about them. The questions may be dichotomous choices which each person would ask the other in the sequence and the person has to just pick one option. Examples of questions could be, coffee or tea, present or future, beach or mountain, summer or winter, movies or lunches, and no on. Hence, the user gets to answer questions which will be asked and at the same gets a chance to frame such questions and ask the next participant in the sequence.

In a second level, a small summary of an individual sharing one of his/her life experiences may be shown to the user. This description may be followed by options comprising both, closed and open ended questions. The user has to then pick one open ended question that he/she would ask the person in the story, in order to keep the conversation going. The user may also have to decide which question belongs to the open ended category and which one to closed.

As an example, the life experience that is shown could be “I was running late and I had to catch the train.” The options comprising closed and open ended questions could be “Oh no. That must have been a close call. Did you catch the train?”, “Oh wow. How did you finally manage to catch the train?”, “Oh so were you on time?”, and “Which destination were you going to?” The most appropriate choice the user could choose may be “Oh wow. How did you finally manage to catch the train?”

In a third level, a small summary of an individual sharing one of his/her life experiences may be shown to the user. The user has to come up with as many open ended questions that he/she can ask in order to keep the conversation going. The user could be allowed to type the questions and/or speak it out. The user has to rate the question as open or closed ended so they act better insight into what they need to ask.

### Actions Database 206

The actions database 206 includes information corresponding to a plurality of exposure activities or sets of exposure activities. Exposure activities may include activities that are performed in a real world environment, as opposed to the digital games played in the virtual world (ex: zones included in the collection of games 204).

Referring to FIG. 2C, each of the exposure activities 220a-220b (may be referred by numeral 220) or sets of exposure activities 220a-220b (may be referred by numeral 220) is used by the activity module 200 based on the brain rewiring, which the exposure activity 220 is capable of achieving.

Each exposure activity 220 may include associated information 222. As an example, an exposure activity may be capable of achieving more than one type of brain rewiring. Each exposure activity 220 includes data indicating the brain rewiring(s) 219, 225 it is capable of achieving, so that the activity module 200 can opt to present a choice of one or more exposure activities 220, which has the capability to achieve the brain rewiring, which the activity module 200 is attempting to achieve.

The associated information 222 may further include instructions 227 to be followed by the user to perform the exposure activity 220 or a set of exposure activities 220. The associated information 222 may additionally include one or more rules 229. Examples of rules include rules to proceed to a higher level, scoring method in each level and time assigned to each level to reach the end of the level, among others.

The exposure activity 220a may be presented to the user after the user has at least participated in one or more games to a predefined extent that attempts to rewire 219 the first defective brain wiring 216a. The exposure activity 220a may be designed rewire the brain to increase the ability to gather information concurrently from multiple sources 219.

In a first level: The activity module 200 may present tasks listed below and may present them sequentially. A “next” option may be provided to show the next task, in case the user cannot or does not wish to perform the task being presented currently.

Instructions: Choose a quiet place to sit in. Close your eyes and imagine in detail what is shown to you below:
Think of one recent moment which made you feel very happy. Imagine re-living that situation and write down all the people who were present with you, things that were kept around you and the environment that you were in.
Think about the most comfortable place in your house and write down all the items present there.
Think about the place in your house that you least frequently visit. Write down everything that is present there.
Think about your entire office and list out all the items present on your desk along with its position.
Think about your journey from your house to your workplace/college. Write down all those events that repeat almost every day and has now become a part of your life.

A box may be provided by the activity module 200 for the user to provide his response.

In a second level: The activity module 200 may present tasks listed below and may present them sequentially. A “next” option may be provided to show the next task, in case the user cannot or does not wish to perform the task being presented currently.

### Screen 1

Today look out for the following details in your surroundings:
Look for the number of red signals that you will cross today
Look for the number of advertisement boards that you see
Look for all the new items on your colleagues desk
Look for the kind of cars in your parking lot
Observe the number of tables around you in a restaurant.
Observe the restaurant set up and the theme that they have followed.
Look for the number of times the cashier is making eye contact with you
Look for the special dining menu for today and what you like the most in the menu

### Screen 2:

At the end of the day, kindly write down what you were asked to observe.

A box may be provided by the activity module 200 for the user to provide his response.

In a third level: The activity module 200 may present tasks listed below and may present them sequentially. A “next” option may be provided to show the next task, in case the user cannot or does not wish to perform the task being presented currently.

### Screen 1:

Today look out for the following people in your surroundings:
Look for the colours which are most frequently worn by the people around you
Look for the number of couples around you
Look for the number of people having a visible tattoo
Look for the number and kind of people in the elevator with you
Look for the number of people wearing headphones today

### Screen 2:

At the end of the day, kindly write down what you were asked to observe.

A box may be provided by the activity module 200 for the user to provide his response.

In a fourth level: The activity module 200 may present tasks listed below and may present them sequentially. A “next” option may be provided to show the next task, in case the user cannot or does not wish to perform the task being presented currently.

Today look out for the following details in your surroundings:
Look at the kind of people around you in a restaurant and observe their dressing styles and behaviors
Look for the number of people who are tall and using headphones
Look for the number of people who are wearing red and who have coloured, short hair
Look for a group of people who are sitting next to your table and observe the general mood of the group, the nature of conversations and their behaviors
Look for the general food aesthetic of people with you and the people around you
Observe the waiter's behavior, in terms of the language he uses, his body language and whether he makes an eye contact with the customers
Observe the dressing ethics of the sales people and cashiers in all the shops that you visit
Observe for the number of mothers and their behavior towards their children
Look for people around you who are in need of any help and go ahead and help them

### Screen 2:

At the end of the day, enter the number; details of the people who fulfilled the criteria given to you. In that list of people who fulfilled the criteria, write down the names of as many people as you know.

A box may be provided by the activity module 200 or the user to provide his response.

In a fifth level: The activity module 200 may present items listed below and may present them sequentially. A “next” option may be provided to show the next task, in case the user cannot or does not wish to perform the task being presented currently.

### Screen 1

Today find out the following information about a new person/someone who you haven't spoken to before, by asking the question to someone close to you:
The name of a person at work/college
Where is the person from?
Where did the person graduate from?
What field has the person graduated in?
The nature of work of the person?
Which school has the person studied in?

### Screen 2:

At the end of the day, kindly write down what you got to know about the new person.

A box may be provided by the activity module 200 for the user to provide his response.

In a sixth level: The activity module 201 may present items listed below and may present them sequentially. A “next” option may be provided to show the next task, in case the user cannot or does not wish to perform the task being presented currently.

### Screen 1

Today find out the following information by talking to a new person by yourself:
Who is your favorite hero?
What are your hobbies?
If you could live anywhere, where would it be?
What is your favorite family vacation?
What motivates you to work hard?
What is your favorite thing about your career?
What is your proudest accomplishment?
What is your favorite book to read?
What makes you laugh the most?
What was the last movie you went to? What did you think?
What did you want to be when you were small?
If you could choose to do anything for a day, what would it be?
What is your favorite game or sport to watch and play?
Would you rather ride a bike, ride a horse, or drive a car?
What would you sing at Karaoke night?
What two radio stations do you listen to in the car the most?
If you could only eat one meal for the rest of your life, what would it be?
Who is your favorite author?
What is your favorite restaurant?
When is your birthday?

### Screen 2:

At the end of the day, kindly write down what you got to know about the new person.

A box may be provided by the activity module 200 for the user to provide his response.

The exposure activity 220b may be presented to the user after the user has at least participated in one or more games to a predefined extent that attempts to rewire 225 the second defective brain wiring 216b. The exposure activity 220a may be designed rewire the brain to increase the speed of verbal response to open ended stimuli 225.

In a first level:

### Screen 1

Think about a situation which happened in the last two days, where you did not respond quickly or did not say what you intended to say. Now write down what you should've said instead.

A box may be provided by the activity module 200 for the user to provide his response.

In a second level:

### Screen 1

You have to respond to your loved ones, which include family and friends in various situations as fast as possible. Whatever question they ask, you need to be quick in answering.

### Screen 2

Write down any situation which occurred during the day where you responded quickly to your loved ones. Write down what exactly you answered.

A box may be provided by the activity module 200 for the user to provide his response.

In a third level:

### Screen 1

You have to respond to your boss/colleagues/teacher or anyone else in authority as fast as possible, in a witty manner.

### Screen 2

Write down any situation which occurred during the day where you responded quickly to any authority figure. Write down what exactly you answered.

A box may be provided by the activity module 20( )for the user to provide his response.

In a fourth level:

### Screen 1

You have to respond quickly to any stranger/any new person who you encounter today, either at work or at college. If they do not ask you anything, you start the conversation. You could talk about anything general.

### Screen 2

Write down any situation which occurred during the day where you responded quickly to any stranger/any new person. Write down what exactly you answered.

A box may be provided by the activity module 200 for the user to provide his response.

In a fifth level:

### Screen 1

Strike a conversation with an extrovert for at least five minutes. You need to respond quickly, and make sure that the conversation does not end too soon. The extrovert could be your friend/family member.

### Screen 2

Write down any situation which occurred during the day where you responded quickly to the extrovert. Write down what exactly you answered.

A box may be provided by the activity module 200 for the user to provide his response.

In a sixth level: The activity module 200 may present tasks listed below and may present them sequentially. A “next” option may be provided to show the next task, in case the user cannot or does not wish to perform the task being presented currently:
Call and talk to a friend who you haven't spoken to for a long time and find out about their general whereabouts
Call and talk to a cousin who you haven't spoken to for a long time and find out about how their family is doing. You could also plan a family meet up
Call and talk to a colleague who is close to you and share anything about your personal life and get to know more about the other person as well
Call and talk to a Teacher/Professor who taught you in the past and find out about their general whereabouts
Talk to your neighbor and find out about their general whereabouts

In a seventh level: The activity module 200 may present tasks listed below and may present them sequentially. A “next” option may be provided to show the next task, in case the user cannot or does not wish to perform the task being presented currently:
Talk to a person in your office/college who you have never interacted with before, and try to get to know more about them as a person
Ask a stranger for directions, irrespective of whether you know the destination or not
Ask a waiter for the special menu and the suggested list of dishes to eat
Strike a conversation with a receptionist at work/college
Talk to the person who is with you when you commute to/from work/college

In an eighth level: Ask your friend to introduce you to a mutual friend and go out with both of them to a new place. Each time get introduced to a new mutual friend and try out a new place.

In a ninth level:

### Screen 1

Spending some time with individuals who share similar interests as you would make you more comfortable around them. Such group activities would enable you to feel more confident about yourself and learn more about effective communication. Hence, it is highly recommended you take some time off every week and join such a club. It is also a nice way to meet new people with similar experiences and have some fun.

### Screen 2

Some of the recommended group activities are:
Hiking/Sports
Trekking
Dance/Music Classes
NGO
Toastmasters
Landmark

In a tenth level:

The activity module 200 may present each category listed below as a selectable options.

1. Family Gatherings

Keep this in mind before you attend a family gathering:
Never Say No to a reasonable request by a loved one
Make memories when spending time with family
Involve everyone in a family gathering
Take time to be grateful to those members who have been there with you through out
Don't consider your relative “somebody else's problem.” Do help them if they are in need
Do initiate a conversation by sitting near the person and speaking in a gentle voice. Do start by introducing yourself (“Hi, I'm Aunt Karen. Your dad is my big brother.”), and make simple statements or observations (“I drove 600 miles to be here with you today.”)
Do include the other person in your conversation and pause to wait for responses. Do find a common interest.
Don't overreact if the person's behavior doesn't meet your expectations.
Do remain calm and think of something positive to say when the crisis is over
Do smile and enjoy growing your family relationships. You'll feel wealthier and healthier by the end of the day
Know when and how to interrupt. Some family members don't talk at all. You can encourage them by leaving space for them to say something and asking respectful (not intrusive) questions
Be mindful about the impact of what you say and do. “Before you speak, think—Is it necessary? Is it true? Is it kind? Will it hurt anyone? Will it improve on the silence?” Don't complain about people behind their backs instead of raising concerns directly
Thank each person in a very specific way for their individual contributions—clearly and repeatedly
Offer to help plan the next event. Give your ideas for what might be fun to do. Rather than complaining, give specific suggestions about to do things in a better way and offer to help to make that happen

2. Parties and Events

Keep this in mind before you attend a party. The activity module 200 may present the below listed instructions sequentially.
Give yourself some direction, a clearly defined role and set of instructions before attending a social event.

Sometimes, it's officially sanctioned. For example, when attending a fundraiser, you might ask a coordinator if you can take raffle tickets.

But sometimes, you have to invent my own “job.” In the case of a cocktail party, a set of instructions may be provided: first, walk to the bar; second, visit the buffet; third, find empty seat; fourth, introduce yourself to someone.
Ask leading questions

More importantly, remember to ask open ended questions in conversations.
Get there early

If walking into a crowded room stresses you out, try getting there early. If possible, really early, when the tables are mostly empty and coordinators are still buzzing around the room, getting things ready.

Why? Not only will you be able to slip into a seat unnoticed and take a few moments to settle in, but you'll also have a chance to get acclimated to the space without having to speak to anyone.
Limit your alcohol intake in order to avoid any unwanted embarrassment.
Offer to bring something, such as food, drinks, gifts and so on.
Remember to say thanks to the host before leaving
Remember to dress appropriately
Pay as much attention to the person on your right as on your left. Your seatmate might have been placed next to a dud, in which case, you'll be saving him or her from a night of boredom.
Good introductions are a sign of good manners. Introduce your date/friend to everyone you greet. If someone greets you but not your date, smooth the situation by making the intro yourself.
Ask questions of others; people love it when you're interested in them, Try: “Did you travel anywhere this summer?” or “What is keeping you busy lately?”
Never discuss politics or religion. They are personal choices.
Limit your chats to two minutes.
Good manners extend into the next day if you've met new friends (and if you follow our advice, you will), follow up promptly via, e-mail or social—or squander the opportunity to cement new connections.

3. Reunions with Friends/Colleagues

Keep this in mind before you attend a reunion with friends/colleagues. The activity module 200 may present the below listed instructions sequentially.
For huge gathering where you know almost nobody

The first thing you will want to do when you arrive is find the person who invited you and make contact.

You might want to ask if there's anything you can do to help out.

If the host is already talking to someone else, go up and stand to the side until you see a good opening in the conversation to say, “Hi, how are you? Thanks for inviting me!” Chances are, at that point, they'll introduce you to the other person they've been talking to.

Once you've introduced yourself (or have been introduced) to a couple of people, start a conversation with them.

If the conversation seems to fade out, then just excuse yourself and head over to the food table, or another group of people to introduce yourself and start another conversation.
If you're walking through the party, and you hear people having a conversation that piques your interest, and you would like to participate in, then find a good opening and join in.
If you see someone all by themselves, that's another great opportunity to go up and introduce yourself and make him/her comfortable.
While exiting try to keep these things in mind:

Be sure to say “goodbye” to any new friends you've made that day who are in your immediate vicinity, and if you can manage it, a quick “goodbye” to the bride and groom.
Small gathering where you know almost nobody

Introduction: This is a situation you might find yourself in if you've recently moved to a new place, started anew job, or made some inroads into anew social circle. It could be a dinner or cocktail party at someone's house, a boardgame night, or a meet-up at a bar or restaurant, where there could be 6-12 people or so. Chances are you know only the person who invited you, or maybe one or two more people
How to navigate to this party:

Be sure that you pay attention to what people are actually saying, rather than thinking about your next response. Participating in conversation doesn't only mean speaking; it means being an active listener. If you listen and absorb, then you'll know when to respond, and how.
In the small gathering where you know no one, there's more pressure on you to put your best foot forward. It is important to remember to just be yourself.
When you are about to leave:

If you have to be up early the next morning, then wait until things are winding down, and take your first available opportunity.

There may be a lull in conversation, the host/hostess may start clearing a few dishes away, or you might notice others starting to get ready to leave

In this situation, you should say your farewells to everyone at the party, and absolutely must say “good night” and “thank you” to your host and/or hostess

Come and relax in your home the way you like.

4. Professional Meetings/Presentations

### The Art of Appreciation

Impress your clients and JY partners by communicating appreciation. Stating “thank you” will elevate you above competitors. Whether large or small, the gesture will have an impact.

Reciprocate with Others
Reciprocate with others who take the time to connect with you.
Follow Up Manners

Follow Up appropriately—it is good manners. If you promise info, deliver it; if you are asked for something, provide it; if you are given a deadline, meet it.
Watch the Clock

Watch the clock. Be on time. End meetings on time. Never use more words when you could use less.
Set a goal. My target is to introduce myself to 5 people (outside of my old gang of friends) and reconnect with 5 others.
Don't only speak to one person—The more the better.
Don't be afraid to ask questions—Everyone is scared of appearing ignorant or stupid but there's no need. The vast majority of people will relish the opportunity to peacock their knowledge and expertise, so make sure you ask as many questions as you can.
Smile.

After all of your preparation, relaxation exercises and affirmations, there's one thing left to do, and it's the simplest thing—smile. Smile at your audience as they enter the room, and smile at them when you begin speaking. This will make you feel relaxed, confident, and connected.
Make small note of important points and conclude at last.
Take a step and ask everyone whether his decision/info/suggestion is correct or incorrect
Prepare to share. Introverts are most comfortable when they have a chance to formulate their thoughts ahead of time. I'm already planning what I want to share about myself.

In a eleventh level:

Mentor another individual who is an introvert (and who wants to change) and guide them on the skills that you have learnt. This person could be your friend/family member or colleague.

In an embodiment, the action database 220 further includes plurality of physical actions, mind actions and dietary actions, one or more of which may be presented to a user who is trying to overcome introversion 214a.

Example of physical actions includes one or more physical activities, such as exercises and physical postures, among others. Example of mind actions may include meditation. Example of dietary actions may include adding specific food to one's diet or deleting specific food from the diet. As a further example, drinking black tea may be a dietary action and cutting down on rice consumption may be another dietary action.

### Logging Module 208

In an embodiment, the logging module 208 enables logging of the activities ex: games, exposure activities and other actions) performed by the user. The logging module 208 may record information corresponding to the activities performed by the user. The information may include one or more of, time of performance, date of performance, quantum of performance, success or failure consequent to an attempt to perform, and extent of success in performing the action, among others. The user may provide input that an activity has been performed. Such input may be used to log the activity in the logging module 208. Alternatively, the logging module 208 may be configured to automatically log the performance of an activity upon detection that the activity has been performed.

### Assessment Module 210

The assessment module 210 of the activity module 200 is configured to determine the performance of a user in each activity the user performs. The assessment module 210 may determine the user's score for each game and at each level in a game based on the log available in the logging module 208. Further, the assessment module 210 analyzes performance of the user in the exposure activities and determines scores of each level of exposure activity based on the log that is present in the logging module 20$. The assessment module 210 may also determine status of the one or more behavioral trait 214 or the brain wiring causing the trait, after engaging in the activities, based on performance of activities suggested by the activity module 200.

### User Interface Module 212

The user interface module 212 may be configured to receive input from the user and display content to the user. The content displayed, can be, as an example, games, images, instructions, rules, information, haptic feedback and sound, among others.

### V. Method for Overcoming Introversion

Now referring more particularly to Hers, 3A-3B, a method is provided for overcoming introversion 214a. A selection indicating introversion 214a as a behavioral trait which a user wishes to overcome is received at step 302. At step 304, a user is enabled to participate/play in at least one digital game 204a, 204b, which is played in a virtual world. The digital games 204a, 20′4b are instrumental in rewiring 219 a first defective brain wiring 216a, whose symptom is exhibition of introversion 214a. At step 306, verification is made to determine whether the user can proceed to perform exposure activities 220a. In case it is determined that user can proceed, then at step 308, instructions are provided to the user to enable the user to perform appropriate exposure activity/activities 220a. Preferably, the user is allowed to perform or instructed to begin performing appropriate exposure activities 220a upon participating in the digital games 204a, 204b at least to a predefined extent, which is determined based on the desired rewiring. The exposure activity 220a is instrumental in rewiring 219 the first defective brain wiring 216a, whose symptom is exhibition of introversion 214a.

At step 310, verification is made to determine whether the user can proceed to playing at least one other digital game 220c-220e in the virtual world directed to rewire a second defective brain wiring 216b causing reduced speed of verbal response to stimuli. In case it is determined that user can proceed, then at step 312 the user is enabled to participate/play in at least one digital game 204c-204e, which is played in a virtual world. The digital games 204c-204e are instrumental in rewiring 225 the second defective brain wiring 216b, whose symptom is exhibition of introversion 214b. Preferably, the user is allowed to proceed to playing at least one other digital game 220c-220e upon participating in the garnets; instrumental in rewiring 219 the first defective wiring 216a at least to a predefined extent, which is determined based on the desired rewiring 225.

At step 314, verification is made to determine whether the user can proceed to perform exposure activities 220b. In case it is determined that user can proceed, then at step 316, instructions are provided to the user to enable the user to perform appropriate exposure activity/activities 220b. Preferably, the user is allowed to perform or instructed to begin performing appropriate exposure activities 220b upon participating in the digital games 204c-204e at least to a predefined extent, which is determined based on the desired rewiring 225. The exposure activity 220b are instrumental in rewiring 225 the second defective brain wiring 216b, whose symptom is exhibition of introversion 214a.

Referring to the step (302) of receiving a selection indicating introversion 214a, the user may be provided an option to select a behavioral trait that he would be like to overcome. The activity module 200 may provide or recommend an option to select at least one weak behavioral trait to work on. The user may select at least one behavioral trait 214 that the user thinks he needs to work on, from a list of behavioral traits that may be displayed to the user via the user interface module 212. Alternatively, the user may input answers in response to a set of questions displayed to the user, which may determine what type of weak behavioral trait 214 the user may have. Upon selection of introversion 214a, the activity module 200 may display a list 216d of other behavioral traits that can be confused with introversion 214a, so that the user can select a more appropriate behavioral trait 214, which he desires to work on. The activity module 200 may further display the information corresponding to the brain wirings (defect) 216a, 216b causing the trait behavioral 214. The first defective brain wiring 216a causes tendency to be selective in information gathering. The second defective brain wiring 216b causes reduced speed of verbal response to open ended stimuli.

The activity module 200 may additionally display information about impact 216c of introversion 214a on the user. In addition, the activity module 200 may display information corresponding to the brain rewiring 219, 225 that the activity module 200 is attempting to achieve to overcome introversion 214a. Rewiring 219 of the first defective brain wiring 216a results in increased ability to gather information concurrently from multiple sources. Rewiring 225 of the second defective brain wiring 216b results in increased speed of verbal response to open ended stimuli.

Furthermore, the activity module 200 may display the information corresponding to the causes (genetic or environmental) that resulted in the defective brain wirings (defect) 216a, 216b.

Referring to the step (304) of enabling the user to play at least one digital game in the virtual world directed to rewire the first defective brain wiring 216a, the activity module 200 may select one or more digital games based on the capability of the digital games to achieve the desired brain rewiring 219.

In an embodiment, the user is presented with a choice comprising one or more games that are directed towards enhancing one's observational skills (ex: game 204a) in general (second scenario). Only after the user has participated in the game(s) directed towards enhancing one's observational skills in general to a desired extent, the user is presented (to participate) with a choice comprising one or more games that are directed towards enhancing one's observational skills in social situations (ex: game 204b) (first scenario), which is more difficult for introverts. Said sequence makes it easier for introverts to overcome the first defective brain wiring 216a.

The activity module 200 may provide a choice (one or more games) of games, from which the user may select. The activity module 200 may even indicate the effectiveness of each of the games in achieving the desired brain rewiring 219 or an aspect of rewiring, such as enhancing ones observational skills in general and enhancing one's observational skills in social situations.

In an embodiment, the activity module 200 is configured to recommend a plurality of games 204, wherein the recommendation indicates each of the games' 204 effectiveness to achieve the desired brain rewiring 219 or an aspect of rewiring, such as enhancing one's observational skills in general and enhancing one's observational skills in social situations.

The activity module 200 allows the user to play the selected game. The logging module 208 may log the performance of the user. The assessment module 210 may determine the performance scores using the log in the logging module 208. Further, based on the respective rules 223, the user is either allowed or denied access to other levels of the game 204.

Referring to step 306, the activity module 20( )verifies whether the user can proceed to perform exposure activities 220. Preferably, the activity module 200 recommends exposure activities 220 after the user has performed to a desired extent in the digital game(s) 204. Desired extent of performance can be, as an example, levels completed, score reached and duration over which the game 204 was played.

In an embodiment, the activity module 200 recommends (step 308) participating in exposure activity 220a or a part thereof, after the user has performed to a desired extent in the digital game 204a. Likewise, the activity module 200 may recommend participating in the exposure activity 220a or a part thereof, after the user has performed to a desired extent in the digital game 204b. Desired extent of performance can be, as an example, levels completed, score reached and duration over which the game(s) were played.

In an embodiment, the activity module 200 recommends participating in a level or part of exposure activity (ex: level of exposure activity 220a) after the user has performed to a desired extent in a level of the digital game (ex: level of digital game 204a), wherein the level of the digital game prepares the user to participate in the level or part of the exposure activity.

In an embodiment, the activity module 200 is configured to recommend a plurality of exposure activities or sets of exposure activities 220, wherein the recommendation indicates each of the exposure activities' or sets of exposure activities' 220 effectiveness to achieve the desired brain rewiring.

The logging module 208 may log the performance of the user. The assessment module 210 may determine the performance scores using the log in the logging module 208. Further, based on the rules 229, the user is either allowed or denied access to other levels of the exposure activities or sets of exposure activities.

Referring to step 310, the activity module 200 verifies whether the user can proceed to playing at least one other digital game in the virtual world directed to rewire the second defective brain wiring 216b causing reduced speed of verbal response to open ended stimuli. Rewiring the second defective brain wiring 216b results in increased speed of verbal response to open ended stimuli 225.

In an embodiment, the activity module 200 recommends participating in digital games directed to rewire the second defective brain wiring 216b after the user has performed to a desired extent in the digital game(s) directed to rewire the first defective brain wiring 216a.

In an embodiment, the activity module 200 recommends participating in digital games directed to rewire the second defective brain wiring 216b after the user has performed to a desired extent in the digital game(s) and exposure activity/activities directed to rewire the first defective brain wiring 216a.

The activity module 200, based on the verification, enables the user to play/participate in at least one other digital game 204c-204e in the virtual world directed to rewire the second defective brain wiring.

In an embodiment, digital game(s) (ex: Expect the Unexpected 204c) that increases the speed with which the brain processes events is presented to the user for participation. The digital game(s) (ex: Emotion Tracker 204d) that improve the way brain processes social input, so that one can correctly interpret facial expressions and body language may be presented to the user for participation after the user has participated in the game(s) that increases the speed with which the brain processes events, at least to a desired extent. The digital game(s) (ex: Express to Impress 204e) that enables one to understand what needs to be asked and spoken in social situations may be presented to the user for participation after the user has participated in the game(s) that improve the way brain processes social input, at least to a desired extent.

In an embodiment, the activity module 200 recommends (steps 314, 316) participating in exposure activity 220b or part thereof after the user has performed to a desired extent in the digital game 204c. Likewise, the activity module 200 recommends participating in exposure activity 220b or part thereof after the user has performed to a desired extent in the digital game 204d. Similarly, the activity module 200 recommends participating in exposure activity 220b or part thereof after the user has performed to a desired extent in the digital game 204e.

In an embodiment, the activity module 200 recommends participating in a level or part of exposure activity after the user has performed to a desired extent in a level of the digital game (ex: level of digital game 204c), wherein the level of the digital game prepares the user to participate in the level or part of the exposure activity. Likewise for the other digital games.

Additionally, the activity module 200 may provide instruction to perform mind actions, physical actions and dietary actions.

Each of the physical and dietary actions may have effect on one or more hormones corresponding to one or more traits, among others. While executing the physical action the energy expended in the body is more compared to the energy expended while playing brain game. Similarly, the mind action may involve thinking about the specific trait in a way which may change the structure of the brain by changing the Axons, Receptors and/or the number of Neurons. The dietary action may include consuming specific foods which changes one or more hormone levels.

The exposure, mind, physical and dietary activities are carried out in a real environment. Automated instructions are provided as to when and how the activities may have to be carried out. Further, there may be instructions that one or more of the real world activities may have to be carried out simultaneously with the brain games and one or more of the activities may have to be carried out prior to or after engaging in brain game (digital games) and performing to a desired extent.

In an embodiment, upon selecting introversion, the activity module 200 provides a scale operable by the user to select a position on the scale. The position may be indicative of the user's perception of how introvert he is. Improvement in introversion resulting from the rewiring of the brain achieved by the performance of the activities (virtual games or exposure activities) enabled by the activity module 200 is reflected on the scale. Degradation of the improvement in introversion resulting from the degradation of the rewiring of the brain due to premature halt in performance of the activities (virtual games or exposure activities) enabled by the activity module 200 is also reflected on the scale.

The games and the exposure activities change the neural connections in the brain. When these activities are carried out repeatedly, new neural connections are formed (brain plasticity) but if one stops carrying out these activities prematurely then slowly the neural connections die.

The processes described above is described as sequence of steps, this was done solely for the sake of illustration. Accordingly, it is contemplated that some steps may be added, some steps may be omitted, the order of the steps may be re-arranged, or some steps may be performed simultaneously.

The example embodiments described herein may be implemented in an operating environment comprising software installed on a computer, in hardware, or in a combination of software and hardware.

Although embodiments have been described with reference to specific example embodiments, it will be evident that various modifications and changes may be made to these embodiments without departing from the broader spirit and scope of the system and method described herein. Accordingly, the specification and drawings are to be regarded in an illustrative rather than a restrictive sense.

Many alterations and modifications of the present invention will no doubt become apparent to a person of ordinary skill in the art after having read the foregoing description. It is to be understood that, the phraseology or terminology employed herein is for the purpose of description and not of limitation. It is to be understood that the description above contains many specifications, these should not be construed as limiting the scope of the invention but as merely providing illustrations of some of the personally preferred embodiments of this invention.

What is claimed is:

1. A system for enabling a user to overcome introversion, the system comprising an activity module configured to:
enable the user to engage in at least a first activity in a virtual environment, wherein the first activity is directed to rewire a first defective wiring of the brain, wherein the first defective wiring results in tendency to be selective in information gathering;
enable the user to engage in at least a second activity in the virtual environment, wherein the second activity is directed to rewire a second defective wiring of the brain, wherein the second defective wiring results in reduced speed of verbal response to open ended stimuli, wherein symptom of the first and the second defective wirings is introversion, wherein engagement in the second activity is enabled after the user has at least participated in the first activity;
provide automated instructions to the user to engage in at least one activity, wherein the one activity is performed in a real world environment, wherein the activity is directed to rewire the first defective wiring of the brain; and
provide automated instructions to the user to engage in yet another activity, wherein the yet another activity is performed in the real world environment, wherein the yet another activity is directed to rewire the second defective wiring of the brain.

2. The system of claim 1, wherein the activities in the virtual environment are digital games.

3. The system of claim 2, wherein the activity module is configured to enable the user to participate in a game or a level of a game that is directed to enhance observation skill of an introvert in first scenario, after enabling the user to participate in a different game or a different level of the game that is directed to enhance observation skill of the introvert in a second scenario, wherein the first scenario is more difficult than the second scenario for the introvert, wherein the games or the levels of the game are collectively directed to rewire the first defective wiring.

4. The system of claim 3, wherein the activity module is configured to provide automated instructions to the user to engage in a plurality of activities, wherein the plurality of activities are performed in the real world environment, wherein instructions to the user are provided to engage in at least one of the activities among the plurality of activities, which is directed to enhance observation skill of the introvert in the first scenario, after providing instructions to the user to engage in at least another activity among the plurality of activities, which is directed to enhance observation skill of the introvert in the second scenario, wherein the plurality of activities are collectively directed to rewire the first defective wiring.

5. The system of claim 4, wherein the activity module is configured to:
provide the instructions to the user to engage in the activity, which is directed to enhance observation skill of the introvert in the second scenario, after enabling the user to participate in the game or the level of the game that is directed to enhance observation skill of the introvert in the second scenario; and
provide the instructions to the user to engage in the activity, which is directed to enhance observation skill of the introvert in the first scenario, after enabling the user to participate in the game or the level of the game that is directed to enhance observation skill of the introvert in the first scenario.

6. The system of claim 2, wherein the activity module is configured to enable the user to:
participate in a game or a level of a game that is directed to increase the speed with Which the brain processes events;
participate in a game or a level of the game that is directed to improve the way the brain interprets facial expressions and body language, after enabling the user to participate in the game or the level of the game that is directed to increase the speed with which the brain processes events; and
participate in a game or a level of the game that is directed to enable one to understand what needs to be asked and spoken in social situations, after enabling the user to participate in the game or the level of the game that is directed to improve the way the brain interprets facial expressions and body language, wherein the games or the levels of the game are collectively directed to rewire the second defective wiring.

7. The system of claim 6, wherein the activity module is configured to provide automated instructions to the user to engage in a plurality of activities, wherein the plurality of activities are performed in the real world environment, wherein,
instructions to the user are provided to engage in at least one of the activities among the plurality of activities, which is directed to increase the speed with which the brain processes events;
instructions to the user are provided to engage in at least one of the activities among the plurality of activities, which is directed to improve the way the brain interprets facial expressions and body language, after providing instructions to engage in the activity directed to increase the speed with which the brain processes events; and
instructions to the user are provided to engage in at least one of the activities among the plurality of activities, which is directed to enable one to understand what needs to be asked and spoken in social situations, after providing instructions to engage in the activity directed to improve the way the brain interprets facial expressions and body language, wherein the plurality of activities are collectively directed to rewire the second defective wiring.

8. The system of claim 7, wherein the activity module is configured to:
provide the instructions to the user to engage in the activity, which is directed to increase the speed with which the brain processes events, after enabling the user to participate in the game or the level of the game that is directed to increase the speed with which the brain processes events;
provide the instructions to the user to engage in the activity, which is directed to improve the way the brain interprets facial expressions and body language, after enabling the user to participate in the game or the level of the game that is directed to improve the way the brain interprets facial expressions and body language; and
provide the instructions to the user to engage in the activity, which is directed to enable one to understand what needs to be asked and spoken in social situations, after enabling the user to participate in the game or the level of the game that is directed to enable one to understand what needs to be asked and spoken in social situations.

9. A method for enabling a user to overcome introversion, the method comprising:
enabling the user to engage in at least a first activity in a virtual environment, wherein the first activity is directed to rewire a first defective wiring of the brain, wherein the first defective wiring results in tendency to be selective in information gathering;
enabling the user to engage in at least a second activity in the virtual environment, wherein the second activity is directed to rewire a second defective wiring of the brain, wherein the second defective wiring results in reduced speed of verbal response to open ended stimuli, wherein symptom of the first and the second defective wirings is introversion, wherein engagement in the second activity is enabled after the user has at least participated in the first activity;
providing automated instructions to the user to engage in at least one activity, wherein the one activity is performed in a real world environment, wherein the activity is directed to rewire the first defective wiring of the brain; and
providing automated instructions to the user to engage in yet another activity, wherein the yet another activity is performed in the real world environment, wherein the yet another activity is directed to rewire the second defective wiring of the brain.

10. The method of claim 9, wherein the activities in the virtual environment are digital games.

11. The method of claim 10, wherein, the user is enabled to participate in a game or a level of a game that is directed to enhance observation skill of an introvert in first scenario, after enabling the user to participate in a different game or a different level of the game that is directed to enhance observation skill of the introvert in a second scenario, wherein the first scenario is more difficult than the second scenario for the introvert, wherein the games or the levels of the game are collectively directed to rewire the first defective wiring.

12. The method of claim 11, wherein automated instructions are provided to the user to engage in a plurality of activities, wherein the plurality of activities are performed in the real world environment, wherein instructions to the user are provided to engage in at least one of the activities among the plurality of activities, which is directed to enhance observation skill of the introvert in the first scenario, after providing instructions to the user to engage in at least another activity among the plurality of activities, which is directed to enhance observation skill of the introvert in the second scenario, wherein the plurality of activities are collectively directed to rewire the first defective wiring.

13. The method of claim 12, wherein,
the instructions are provided to the user to engage in the activity, which is directed to enhance observation skill of the introvert in the second scenario, after enabling the user to participate in the game or the level of the game that is directed to enhance observation skill of the introvert in the second scenario; and
the instructions are provided to the user to engage in the activity, which is directed to enhance observation skill of the introvert in the first scenario, after enabling the user to participate in the game or the level of the game that is directed to enhance observation skill of the introvert in the first scenario.

14. The method of claim 10, wherein the user s enabled to:
participate in a game or a level of a game that is directed to increase the speed with which the brain processes events;
participate in a game or a level of the game that is directed to improve the way the brain interprets facial expressions and body language, after enabling the user to participate in the game or the level of the game that is directed to increase the speed with which the brain processes events; and
participate in a game or a level of the game that is directed to enable one to understand what needs to be asked and spoken in social situations, after enabling the user to participate in the game or the level of the game that is directed to improve the way the brain interprets facial expressions and body language, wherein the games or the levels of the game are collectively directed to rewire the second defective wiring.

15. The method of claim 14, wherein the automated instructions are provided to the user to engage in a plurality of activities, wherein the plurality of activities are performed in the real world environment, wherein, instructions to the user are provided to engage in at least one of the activities among the plurality of activities, which is directed to increase the speed with Which the brain processes events;
instructions to the user are provided to engage in at least one of the activities among the plurality of activities, which is directed to improve the way the brain interprets facial expressions and body language, after providing instructions to engage in the activity directed to increase the speed with which the brain processes events; and
instructions to the user are provided to engage in at least one of the activities among the plurality of activities, which is directed to enable one to understand what needs to be asked and spoken in social situations, after providing instructions to engage in the activity directed to improve the way the brain interprets facial expressions and body language, wherein the plurality of activities are collectively directed to rewire the second defective wiring.

16. The method of claim 15, wherein,
the instructions are provided to the user to engage in the activity, which is directed to increase the speed with which the brain processes events, after enabling the user to participate in the game or the level of the game that is directed to increase the speed with which the brain processes events;
the instructions are provided to the user to engage in the activity, which is directed to improve the way the brain interprets facial expressions and body language, after enabling the user to participate in the game or the level of the game that is directed to improve the way the brain interprets facial expressions and body language; and
the instructions are provided to the user to engage in the activity, which is directed to enable one to understand what needs to be asked and spoken in social situations, after enabling the user to participate in the game or the level of the game that is directed to enable one to understand what needs to be asked and spoken in social situations.

17. A system for enabling a user to overcome introversion, the system comprising an activity module configured to:
enable the user to engage in at least a first activity in a virtual environment, wherein the first activity is directed to rewire a first defective wiring of the brain, wherein the first defective wiring results in tendency to be selective in information gathering; and
enable the user to engage in at least a second activity in the virtual environment, wherein the second activity is directed to rewire a second defective wiring of the brain, wherein the second defective wiring results in reduced speed of verbal response to open ended stimuli, wherein symptom of the first and the second defective wirings is introversion, wherein engagement in the second activity is enabled after the user has at least participated in the first activity.

18. The system of claim 17, wherein,
the first activity is directed to rewire the first defective wiring to increase the ability to gather information concurrently from multiple sources; and the second activity is directed to rewire the second defective wiring to increase speed of verbal response to open ended stimuli.
